(19) United States
(12) Patent Application Publication
(10) Pub. No.: US 2024/0172753 A1
(43) Pub. Date: May 30, 2024

(54) AGRICULTURAL FORMULATIONS

(71) Applicant: Stepan Company, Northbrook, IL (US)

(72) Inventors: Elodie SHAW, Fontaine (FR); Rémi STEINER, Jarrie (FR); Sandrine MONTHEIL, Grenoble (FR); Christophe FLINOIS, La Murette (FR)

(21) Appl. No.: 18/284,085

(22) PCT Filed: Mar. 24, 2022
(86) PCT No.: PCT/US2022/021828

§ 371 Date: Sep. 26, 2023

Related U.S. Application Data
(60) Provisional application No. 63/167,847, filed on Mar. 30, 2021.

(51) Int. Cl. A01N 43/90; A01N 25/04; A01N 25/32; A01P 13/02

(52) U.S. Cl. CPC A01N 43/90; A01N 25/04; A01N 25/32; A01P 13/02

(57) ABSTRACT

Agricultural concentrates, particularly emulsifiable concentrates, are disclosed. The agricultural concentrates comprise a 3-alkoxy-4-aryl-5-oxopyrazoline compound, an emulsifier, and an adjuvant comprising one or more C₆-C₁₄ triglycerides. The adjuvants surprisingly enhance herbicidal efficacy of the oxopyrazoline compound while limiting its decomposition in the concentrates. Water-diluted formulations resist phase separation and control grassy weeds well without harming crops such as winter barley or winter wheat. The triglycerides are an efficacious, non-irritating, sustainable alternative to the phosphate esters now used as pinoxaden adjuvants.

### FIELD OF THE INVENTION

The invention relates to herbicidal formulations and, more particularly, to agricultural concentrates having good actives stability and herbicidal efficacy.

### BACKGROUND OF THE INVENTION

Phenylpyrazolines, particularly 3-alkoxy-4-aryl-5-oxopyrazoline compounds such as pinoxaden, target grass-like weeds and are well-known herbicides for both wheat and barley (see, e.g., U.S. Pat. Nos. 6,410,180, 6,552,187, and 8,119,566). Pinoxaden-based products were originally developed by Syngenta.

Pinoxaden is commonly used with a “safener,” which moderates the activity of the herbicide to better preserve the desired crop. Cloquintocet-mexyl, a 5-chloroquinoline derivative, is widely used as a safener for pinoxaden.

Pinoxaden is usually formulated as an emulsifiable concentrate. The concentrates include pinoxaden, one or more emulsifiers, and a major proportion of one or more organic solvents, commonly aromatic hydrocarbons.

When used alone, pinoxaden has limited efficacy, so it is normally combined with an adjuvant. Commercial formulations from Syngenta include a trialkylphosphate ester such as tris(2-ethylhexyl)phosphate as the adjuvant. Organophosphate esters have some disadvantages: they are skin irritants, and they are petrochemically based, i.e., not biorenewable.

Few adjuvants can be “built in” as part of the pinoxaden concentrate formulation; most must be “tank mixed” in the spray water just prior to use, which is less convenient. Despite the potential convenience of a built-in adjuvant, pinoxaden poses challenges in formulating concentrates with built-in adjuvants. For instance, a high proportion of adjuvant is needed because a built-in adjuvant will be applied at the same dilution rate as pinoxaden. Unfortunately, pinoxaden tends to degrade when it is mixed with other chemicals (including a large proportion of adjuvant) and stored. Moreover, concentrates require long-term shelf stability, e.g., at least two years under the wide range of temperature and humidity conditions that might exist (for instance) in a barn with no climate control.

Challenges remain in identifying adjuvants that can successfully activate pinoxaden to maximize its herbicidal effectiveness. Concentrates with “built in” adjuvancy that can be stored for years under a combination of alternating hot/humid and freezing conditions while limiting degradation of the pinoxaden are needed. Ideally, the adjuvants used would be an efficacious, bio-based alternative to the organophosphate esters now available.

### SUMMARY OF THE INVENTION

In one aspect, the invention relates to agricultural concentrates. The concentrates comprise a 3-alkoxy-4-aryl-5-oxopyrazoline compound, an emulsifier, and an adjuvant comprising one or more C₆-C₁₄ triglycerides.

In some aspects, the agricultural concentrates further comprise a safener, one or more organic solvents, an agricultural active other than the 3-alkoxy-4-aryl-5-oxopyrazoline compound, or some combination of these.

In some aspects, the agricultural concentrate is combined with water to give aqueous emulsions, microemulsions, or suspoemulsions that can be further diluted by the user.

In preferred aspects, the 3-alkoxy-4-aryl-5-oxopyrazoline compound is pinoxaden.

We surprisingly found that adjuvants comprising one or more C₆-C₁₄ triglycerides enhance the herbicidal efficacy of 3-alkoxy-4-aryl-5-oxopyrazoline compounds, particularly pinoxaden, while limiting degradation of the agricultural active. The agricultural concentrates have good elevated-temperature stability, suggesting that concentrates with “built in” triglyceride adjuvants can be manufactured and stored long-term under ambient conditions. Dilution of the concentrates provides oil-in-water emulsions that resist phase separation. The formulations control grassy weeds well without harming crops such as winter barley or winter wheat. The triglycerides are an efficacious, non-irritating, sustainable alternative to the phosphate esters now used as pinoxaden adjuvants.

### BRIEF DESCRIPTION OF THE DRAWINGS

FIG. 1 is a graph showing stability of pinoxaden emulsifiable concentrates following storage for 2 weeks at 54° C. at 17 or 34 wt. % adjuvant for a series of adjuvants.

FIGS. 2A and 2B are photographs showing results of phytotoxicity testing on (respectively) winter barley and winter wheat for (from left to right) a pinoxaden control sample with no adjuvant versus pinoxaden formulations containing 15 wt. % STEPAN® 108, 30 wt. % STEPAN® 108, and 30 wt. % of tris(2-ethylhexyl)phosphate as an adjuvant.

FIGS. 3A-3D are photographs showing results of herbicidal efficacy testing using the pinoxaden formulations described above when tested on the following weeds: Agrostis capillaris (AGRCA, FIG. 3A), Lolium perenne (LOLPE, FIG. 3B), Alopecurus myosuroides (ALOMY, FIG. 3C), and Avena fatua (AVEFA, FIG. 3D).

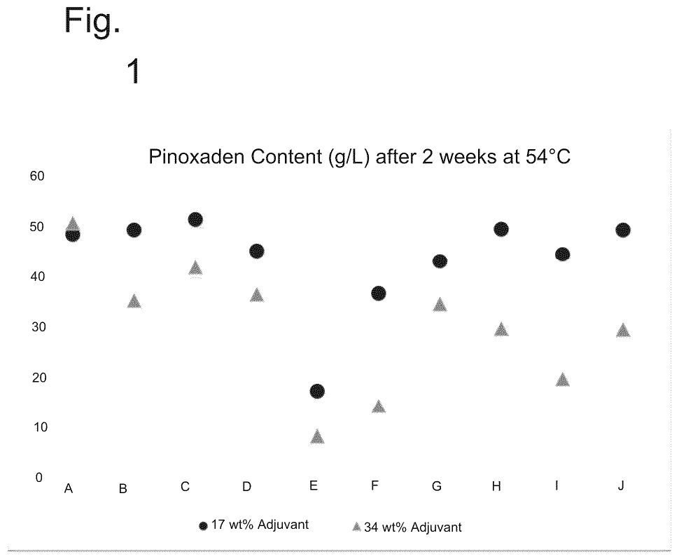

### DETAILED DESCRIPTION OF THE INVENTION

### Agricultural Concentrates

In some aspects, the invention relates to agricultural concentrates that include a 3-alkoxy-4-aryl-5-oxopyrazoline compound, an emulsifier, and a triglyceride.

### Oxopyrazoline Compound

Suitable oxopyrazoline compounds are 3-alkoxy-4-aryl-5-oxopyrazolines. The structures and suitable processes for synthesizing many of these compounds are described, for example, in U.S. Pat. Nos. 6,410,180, 6,552,187, 7,915,199, and 8,119,566, the teachings of which are incorporated herein by reference.

In some aspects, the oxopyrazoline compounds have the general structure:

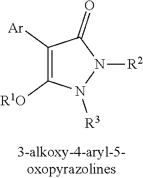

wherein Ar is an aryl group that may be substituted with alkoxy, alkyl, alkylaryl, amino, aryl, halo, hydroxy, or nitro groups, preferably with C₁-C₄ alkyl groups; R¹ is alkyl, aryl, alkylaryl, or acyl, especially a C₂-C₈ acyl group; and R² and R³ are alkyl, alkoxy, aryl, or alkylaryl groups or may be joined to form a 5-, 6-, 7-, or 8-membered ring that optionally includes O, N, or S.

In a preferred aspect, the oxopyrazoline compound is pinoxaden, a well-characterized herbicide that has the structure:

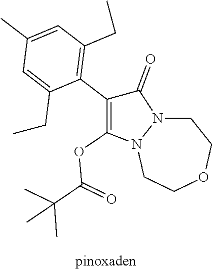 [SMILES: CCc1cc(C)cc(CC)c1-c1c(OC(=O)C(C)(C)C)n2n(c1=O)CCOCC2]

Pinoxaden, first commercialized by Syngenta, is suitable for use on non-oat cereal grains such as wheat, barley, rye, and triticale, particularly wheat and/or barley as well as cotton, soya, sugar beet, rice, and other crops, as discussed in U.S. Pat. No. 7,815,199. It is usually applied post-emergence to control grassy weeds from the Alopecurus, Apera, Avena, Lolium, Phalaris, Setaria and other families (see, e.g., the '199 patent at col. 27).

In some aspects, the agricultural concentrate comprises 1 to 20 wt. %, 2 to 10 wt. %, or 3 to 8 wt. % of the oxopyrazoline compound, based on the amount of concentrate.

### Safener

In some aspects, the agricultural concentrates include a “safener,” which moderates the activity of the herbicide. Suitable safeners are well known and have been described, for example, in U.S. Pat. Nos. 6,555,499 and 7,915,199, the teachings of which are incorporated herein by reference. Suitable safeners include, for example, cloquintocet and cloquintocet salts, including the alkali metal, alkaline earth metal, ammonium, and sulfonium salts; cloquintocet-mexyl (the 2-heptyl ester of cloquintocet); mefenpyr and mefenpyr salts, including the alkali metal, alkaline earth metal, ammonium, and sulfonium salts; mefenpyr-ethyl; bnoxacor, cyometrinil, 2,4-D, dichlormid, dymron, fenclorim, flurazole, fluxofenim, furilazole, isoxadifen-ethyl, oxabetrinil, and the like, and combinations thereof. Cloquintocet, cloquintocet salts, and cloquintocet-mexyl are preferred.

The oxopyrazoline compound and the safener can be used in a wide range of proportions. When a safener is used, the molar ratio of oxopyrazoline compound to safener is typically within the range of 100:1 to 1:10 or from 10:1 to 1:1.

In some aspects, the agricultural concentrate comprises 0.1 to 4 wt. %, or 0.2 to 2 wt. %, or 0.4 to 1.5 wt. % of the safener, based on the amount of concentrate.

### Solvent

In some aspects, the agricultural concentrates comprise one or more organic solvents, typically water-immiscible organic solvents. Suitable water-immiscible organic solvents include hydrocarbons, alcohols, ethers, glycols, glycol ethers, ketones, esters, ethers, alkylene carbonates, glycol ether esters, and the like, and mixtures thereof. For examples of suitable water-immiscible organic solvents, see U.S. Pat. No. 10,314,305 and U.S. Publ. No. 2009/0005246, the teachings of which are incorporated herein by reference.

In some aspects, the solvents include an aromatic hydrocarbon, commonly a mixture of two or more aromatic hydrocarbon compounds, typically “heavy” aromatics. These mixtures are commonly sold by ExxonMobil, Shell, and a wide range of distributors according to the boiling range or flash point of the mixture. Examples include Exxon Mobil's SOLVESSO™ solvents such as SOLVESSO™ 200 and SOLVESSO™ 200 ND, and the like. In some aspects, the organic solvent consists of or consists essentially of aromatic hydrocarbons. In some aspects, the organic solvent has a flash point greater than 80° C.

The organic solvent is frequently a major component of the agricultural concentrate. Thus, in some aspects, the concentrate comprises 30 to 90 wt. %, 40 to 80 wt. %, or 50 to 70 wt. % of the organic solvent(s), based on the amount of concentrate.

### Emulsifier

The agricultural concentrates include an emulsifier. In some aspects, the emulsifier is a combination of one or more anionic surfactants and one or more nonionic surfactants. The identity and proportion of emulsifiers used will depend on the nature of the agricultural active(s) and any safener(s) used, the nature and proportion of any solvents, the nature and proportion of the triglyceride, and other factors. The emulsifier may include some proportion of amphoteric or cationic surfactants, but in many cases, a combination of anionic and nonionic surfactants will be preferred.

Suitable anionic surfactants include, for example, alkyl sulfates, alkyl ether sulfates, olefin sulfonates, α-sulfonated alkyl esters (particularly α-sulfonated methyl esters), α-sulfonated alkyl carboxylates, alkylbenzene sulfonates, sulfoacetates, sulfosuccinates, alkane sulfonates, alkylphenol alkoxylate sulfates, phosphate esters, and the like, and mixtures thereof. Suitable anionic surfactants include, for instance, salts of C₅-C₂₀ linear alkylbenzene sulfonates, alkyl ester sulfonates, C₆-C₂₂ primary or secondary alkane sulfonates, C₆-C₂₄ olefin sulfonates, alkyl glycerol sulfonates, fatty acyl glycerol sulfonates, fatty oleyl glycerol sulfonates, and the like, and mixtures thereof.

Many suitable anionic surfactants are commercially available from Stepan Company and are sold under the ALPHA-STEP®, BIO-SOFT®, BIO-TERGE®, CEDEPAL®, NACCONOL®, NINATE®, POLYSTEP®, STEOL®, STEPANATE®, and STEPANOL® trademarks. For further examples of suitable anionic surfactants, see U.S. Pat. No. 6,528,070, the teachings of which are incorporated herein by reference. Additional examples of suitable anionic surfactants are described in U.S. Pat. Nos. 3,929,678, 5,929,022, 6,399,553, 6,489,285, 6,511,953, 6,949,498, and U.S. Pat. Appl. Publ. No. 2010/0184855, the teachings of which are incorporated herein by reference.

In some aspects, alkylbenzene sulfonates, such as NINATE® 60EPG, NINATE® 401-A, or NINATE® 60E (calcium alkylbenzene sulfonates, products of Stepan Company) are preferred.

Suitable nonionic surfactants include, for example, ethoxylated alcohols, ethoxylated alkylphenols, ethoxylated castor oils, ethoxylated fatty acids, ethoxylated fatty amines, ethoxylated sorbitol esters, block copolymers of EO and PO, ethoxylated alkanolamides, ethoxylated carbohydrate esters, and the like, and combinations thereof. The nonionic surfactants are commonly alkoxylated with ethylene oxide units or combinations of ethylene oxide units and propylene oxide or other alkylene oxides.

Many suitable nonionic surfactants are commercially available. Alcohol ethoxylates and alkylphenol ethoxylates include those available from Stepan Company under the BIO-SOFT®, MAKON®, and POLYSTEP® marks. Suitable amine ethoxylates include ethoxylated cocamines, for example, Stepan's TOXIMUL® CA-2 and TOXIMUL® CA-7.5. Suitable ethoxylated carbohydrate esters include ethoxylated sorbitol esters such as Stepan's TOXIMUL® SEE-340 and TOXIMUL® SEE-341. Suitable ethoxylated alkanolamides include PEG cocamides and PEG lauramides, for example, Stepan's NINOL® C-4, NINOL® C-5, and NINOL® L-5. Suitable ethoxylated oils include ethoxylated castor oils, for example, Stepan's TOXIMUL® 8240, TOXIMUL® 8241, and TOXIMUL® 8242. Suitable EO-PO block copolymers include TOXIMUL® 8320, TOXIMUL® 8323/33, STEP-FLOW® 26F, from Stepan, PLURONIC® copolymers from BASF, and the like. Suitable ethoxylated fatty acids include Stepan's NINEX® products, such as NINEX® MT-603, NINEX® MT-610, NINEX® MT-615, and NINEX® MT-630F, and the like.

Some suitable surfactants are sold as anionic/nonionic blends. Examples include the TOXIMUL® 3400-series blends available from Stepan Company, such as TOXIMUL® 3403F, TOXIMUL® 3453F, TOXIMUL® 3465F, TOXIMUL® 3479F, and the like.

In a specific aspect, the anionic surfactant is an alkylbenzene sulfonate and the nonionic surfactant is selected from fatty alcohol ethoxylates, castor oil ethoxylates, ethoxylated fatty acids, and EO/PO block copolymers.

The agricultural concentrates comprise 0.5 to 20 wt. %, or 1 to 10 wt. %, or 2 to 8 wt. % of the emulsifier(s).

### Triglyceride

The agricultural concentrates comprise an adjuvant comprising one or more C₆-C₁₄ triglycerides, also referred to herein as “medium-chain” triglycerides. The fatty acid residues that make up the triglyceride can have any combination of linear or branched chains within the C₆-C₁₄ range and can be saturated, unsaturated, or some combination of these. In some aspects, the triglyceride comprises predominantly or exclusively saturated C₁₀-C₁₂ or saturated C₈-C₁₀ fatty acid residues. In some aspects, the adjuvant consists of or consists essentially of the C₆-C₁₄ triglycerides.

Those skilled in the art will appreciate that medium-chain triglycerides are generally manufactured and supplied as mixtures that contain up to 15 mole %, or 2 to 10 mole %, of diglycerides and can contain up to 3 mole %, or 0.1 to 2 mole %, of monoglycerides.

Suitable medium-chain triglycerides are commercially available. Examples include STEPAN® 108, a triglyceride derived from coconut oil that incorporates residues of C₈ and C₁₀ fatty acids (caprylic acid and capric acid), and NEOBEE® M-5, a triglyceride made using glycerol from vegetable oil sources and medium-chain fatty acids from coconut and palm kernel oils, both products of Stepan Company.

In some aspects, the C₆-C₁₄ triglyceride can be alkyl-substituted at the 2-position, as in the analogous triesters made from trimethylolethane or trimethylolpropane. In some cases, commercial products are available, such as STEPAN® 3T, a C₈-C₁₀ composition made from capric/caprylic acid mixture and trimethylolpropane.

In some aspects, the C₆-C₁₄ triglyceride comprises 95 wt. % or more of C₈-C₁₂ triglycerides, based on the amount of C₆-C₁₄ triglyceride. In other aspects, the C₆-C₁₄ triglyceride comprises 95 wt. % or more of C₈-C₁₀ triglycerides, based on the amount of C₆-C₁₄ triglyceride.

The agricultural concentrate comprises 5 to 50 wt. %, 10 to 35 wt. %, or 15 to 30 wt. % of the adjuvant comprising one or more C₆-C₁₄ triglycerides, based on the amount of concentrate.

In one specific aspect, the agricultural concentrate comprises 1 to 20 wt. % of an 3-alkoxy-4-aryl-5-oxopyrazoline compound; 0.1 to 4 wt. % of a safener; 30 to 90 wt. % of one or more organic solvents; 0.5 to 20 wt. % of an emulsifier; and 5 to 50 wt. % of an adjuvant comprising one or more C₆-C₁₄ triglycerides; wherein the wt. % amounts are based on the amount of the concentrate.

In another specific aspect, the agricultural concentrate comprises 4 to 6 wt. % of pinoxaden; 1 to 1.5 wt. % of cloquintocet-mexyl; 50 to 70 wt. % of one or more organic solvents comprising an aromatic hydrocarbon having a flash point greater than 80° C.; 1 to 7 wt. % a combination of a nonionic surfactant selected from fatty alcohol ethoxylates, castor oil ethoxylates, ethoxylated fatty acids, and EO/PO block copolymers and an anionic surfactant selected from alkylbenzene sulfonates; and 10 to 35 wt. % of an adjuvant comprising one or more C₈-C₁₀ triglycerides; wherein the wt. % amounts are based on the amount of the concentrate.

### Other Herbicidal Actives

The oxopyrazoline compound, emulsifier, and triglyceride adjuvant can be combined with other agricultural actives, which may include one or more other herbicides.

In general, the herbicides are characterized either by their mode of action, by chemical classification, or both. Functionally, suitable other herbicides include inhibitors of acetyl-CoA carboxylase (ACC herbicides), acetolactase synthase inhibitors (ALS inhibitors), photosynthesis inhibitors, protoporphyrinogen-IX-oxidase inhibitors, bleacher herbicides, synthetic auxins, and others described in the HRAC and WSSA classification schemes (found, respectively, at www.hracglobal.com and www.wssa.net).

Suitable herbicides include, for example, anilides, such as diflufenican and propanil; aryl carboxylic acids, such as dichloropicolinic acid, dicamba and picloram; aryloxyalkanoic acids, such as 2,4-D, 2,4-DB, 2,4-DP, fluroxypyr, MCPA, MCPP and triclopyr; aryloxyphenoxyalkanoic acid esters, such as diclofop-methyl, fenoxaprop-ethyl, fluazifop-butyl, haloxyfop-methyl and quizalofop-ethyl; azinones, such as chloridazon and norflurazon; benzamides, such as flamprop; benzenesulfonamides; benzofurans, such as benfuresate and ethofumesate; benzoxazines such as flumioxazin; benzoic acids; benzothiadiazines, such as bentazone; carbamates, such as chlorpropham, desmedipham, phenmedipham and propham; carboxamides, such as napropamide and n-(terazolyl)arylcarboxamides; chloroacetanilides, such as alachlor, acetochlor, butachlor, metazachlor, metolachlor, pretilachlor and propachlor; cineoles, such as cinmethylin; cyclohexanediones; cyclohexenones, such as tralkoxydim; dinitroanilines, such as oryzalin, pendimethalin and trifluralin; diphenyl ethers, such as acifluorfen, bifenox, fluazifop, fluoroglycofen, fomesafen, halosafen, lactofen and oxyfluorfen; dipyridyliums, such as paraquat; 1,1-disubstituted oxiranes, such as tridiphane; hydroxylamines, such as alloxydim, clethodim, cycloxydim, sethoxydim and tralkoxydim; imidazolinones, such as imazethapyr, imazamethabenz, imazamox, imazapic, imazapyr and imazaquin; indanones, such as indanofan; isoxazoles, such as isoxaben; isoxazolidinones, such as clomazone; nitriles, such as bromoxynil, dichlobenile and ioxynil; organophosphonates, such as glyphosates and glufosinates; oxadiazolones, such as oxadiazon; oxyacetamides, such as mefenacet; oxaziclomefones; phenoxyacetic acids; phenoxypropionates; picolinic acids, such as chlopyralid; pyrazolylamides; pyrazolyloxyphenyls; pyrazoles, such as difenzoquat and pyrazolylpyrazoles; pyridine carboxylic acids, such as aminopyralid and clopyralid; pyridazines, such as pyridate, pyridafol, and imidazopyridazines; pyrimidines, such as pyroxsulam; pyrimidinediones, such as saflufenacil; quinolinecarboxylic acids, such as quinchlorac and quinmerac; sulfonamides, such as florasulam, metosulam, and flumetsulam; pyrrolidines, such as flurochloridone; sulfonylanilides; sulfonylureas, such as amidosulfuron, bensulfuron methyl, chlorimuron ethyl, chlorsulfuron, cinosulfuron, foramsulfuron, flupyrsulfuron, mesosulfuron, metsulfuron-methyl, nicosulfuron, primisulfuron, pyrazosulfuron-ethyl, sulfosulfuron thiencarbazone-methyl, thifensulfuron-methyl, triasulfuron, tritosulfuron, and tribenuron-methyl; thiolcarbamates, such as butylates, cycloates, diallates, EPTC, esprocarb, molinates prosulfocarb, thiobencarb and triallates; thioesters, such as dithiopyr; thiophenes, such as methiozolin; triazines, such as atrazine, cyanazine, simazine, simetryne, terbutryne and terbutylazine; triazoles, such as amitrol; triazinones, such as hexazinone, metamitron and metribuzin; triazolylpropanols; triones; uracils, such as lenacil, bromacil, or terbacil; ureas or azole-ureas, such as chlortoluron, diuron, fluometuron, isoproturon, linuron, neburon, siduron, and methabenzthiazuron; and the like, and combinations thereof.

Other suitable herbicidal actives for use in combination with the oxopyrazoline compound are described in U.S. Pat. No. 7,915,199 (especially cols. 8-9); U.S. Pat. No. 10,314,305; and U.S. Publ. No. 2013/0310257, the teachings of which are incorporated herein by reference.

### Other Agricultural Actives

The oxopyrazoline compound and safener can be combined with agricultural actives other than herbicides, which may include one or more insecticides, fungicides, bactericides, acaricides, nematicides, plant-growth regulators, or the like. Examples of these agricultural actives can be found in U.S. Pat. No. 8,119,566 (especially at cols. 67-74) and U.S. Pat. No. 10,694,743, the teachings of which are incorporated herein by reference.

### Stability of the Concentrates

We found that, in contrast to many other screened potential adjuvants, the adjuvant comprising one or more C₆-C₁₄ triglycerides imparts good active chemical stability to the agricultural concentrate. When heated at 54° C. for two weeks (i.e., when tested under stressed conditions designed to mimic longer-term storage at warm ambient temperatures), the inventive concentrates prepared at 17 wt. % or 34 wt. % adjuvant contents retain a high content of pinoxaden and cloquintocet-mexyl actives (see Adjuvant C, Table 3, below). In contrast, most other screened adjuvants more significantly degrade the pinoxaden active. HALLCOMID® M-10, an N,N-dimethyl fatty amide, also demonstrates good active chemical stability in this test.

### Water-Diluted Compositions

Agricultural concentrates are diluted before use with a large proportion of water. It is therefore desirable that the water-diluted compositions resist phase separation. In laboratory-scale experiments such as those described in Example 2 below, this translates to little or no appearance of separating oils, creamy oils, or creams from the water-diluted compositions, ideally over a 24-h period. As shown in Example 2 and Tables 5 and 6, emulsifiable concentrates that include a medium-chain triglyceride demonstrate considerable flexibility regarding the combination of anionic and nonionic surfactants capable of achieving good stability upon dilution of the EC with water. When compared with an EC formulated using HALLCOMID® M-10 as the adjuvant, the EC formulated with STEPAN® 108 is significantly more forgiving in resisting phase separation.

### Agricultural Efficacy

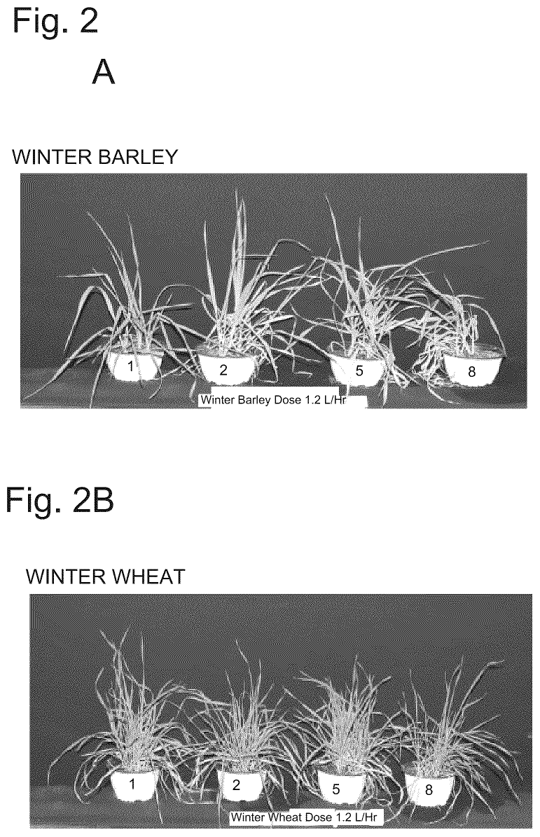

The inventive concentrates also demonstrate good performance in greenhouse testing when compared with AXIAL® Pratic, a commercial product that combines pinoxaden with tris(2-ethylhexyl)phosphate. The inventive ECs exhibit low phytotoxicity to winter barley and winter wheat (FIGS. 2A and 2B). Efficacy in controlling Lolium perenne (LOLPE), Avena fatua (AVEFA), Alopecurus myosuroides (ALOMY), and Agrostis capillaris (AG RCA) at the typical 30 wt. % adjuvant level is comparable to the commercial sample.

Formulators may prefer to use the adjuvants comprising C₆-C₁₄ triglycerides, which have efficacy and formulating properties rivaling those of the organophosphates but are non-irritating, sustainable alternatives.

The following examples merely illustrate the inventive subject matter. Many similar variations within the scope of the claims will immediately be apparent to those skilled in the art.

### Example 1

### Adjuvant Screening for Stability (2 Weeks, 54° C.)

The stability of pinoxaden in emulifiable concentrates and other agricultural formulations depends in part on its ability to resist decomposition in the presence of other formulation components, including any adjuvant. In this experiment, various potential adjuvants are screened under stressed conditions (storage at 54° C. for 2 weeks) for possible use in an emulsifiable concentrate formulation containing pinoxaden (50 g/L), cloquintocet-mexyl safener (12.5 g/L), an aromatic hydrocarbon solvent, a glycol solvent, and a surfactant mixture. Each adjuvant is evaluated at 17 wt. % or 34 wt. % loading. The formulations tested are summarized below:

TABLE 1
Pinoxaden EC Formulations

| | Formulation 1 | Formulation 2 |
|---|---|---|
| Component | (wt. %) | (wt. %) |
| pinoxaden (95.8%) | 5.18 | 5.18 |
| cloquintocet-mexyl (97.1%) | 1.30 | 1.30 |
| SOLVESSO ™ 200 ND solvent | 46.0 | 29.0 |
| hexylene glycol | 23.52 | 23.52 |
| NINATE ® 60 EPG | 2.0 | 2.0 |
| TOXIMUL ® 8241 | 5.0 | 5.0 |
| adjuvant (see Table 2) | 17.0 | 34.0 |

¹ Product of ExxonMobil.
² Products of Stepan Company

TABLE 2
Sample and adjuvant identification

| Adjuvant | | |
|---|---|---|
| ID | Adjuvant name¹ | Description |
| A | trioctyl phosphate (97%) | tris(2-ethylhexyl)phosphate |
| B | HALLCOMID ® M-10 | N,N-dimethyldecanamide |
| C | STEPAN ® 108 | C₈-C₁₀ triglyceride |
| D | STEPAN-MILD ® GCC-L | glyceryl caprate/caprylate |
| | | monoester |
| E | TOXIMUL ® CAAS-5 | cocamide 5EO ether sulfate |
| F | NINOL ® C-5 | PEG-6 cocamide |
| G | DISFLAMOLL ® DPO | 2-ethylhexyl diphenyl phosphate |
| H | STEPAN-MILD ® L3 | lauryl lactyl lactate |
| I | BIO-SOFT ® NC-10 | ethoxylated castor oil |
| J | STEPOSOL ® ROE-W | rapeseed oil methyl ester |

¹Products of Stepan Company except for DISFLAMOLL ® DPO, a product of Lanxess, and trioctyl phosphate (SigmaAldrich).

After storage in an oven at 54° C. for 2 weeks, some samples (not listed) show crystallization and are excluded from further study. Other samples are analyzed by high-performance liquid chromatography (HPLC with a 1260 Infinity instrument from Agilent) and high-resolution mass spectrometry (HRMS with an Impact HD instrument from Bruker). The mobile phase for HPLC contains methanol and water with 5 mM ammonium formate. The column is a silica-based stationary phase modified with branched octadecyl groups.

As shown in Table 3, below, the stressed conditions are generally tougher on the 34 wt. % adjuvant compositions. However, formulations with adjuvants A-D and G offer the best elevated-temperature storage stability with pinoxaden and the safener. These adjuvants are considered suitable for promoting to the next series of tests, which evaluate the ability of the emulsifiable concentrates to produce stable aqueous emulsions.

TABLE 3
Stability (2 weeks, 54° C.) of Pinoxaden EC formulations:
Actives content of Pinoxaden at 17 wt. % or 34 wt. % Adjuvant

| | Formulation 1 | Formulation 2 |
|---|---|---|
| Adjuvant | 17 wt. % adjuvant | 34 wt. % adjuvant |
| ID | pinoxaden, g/L | pinoxaden, g/L |
| A | 49 | 51 |
| B | 50 | 35 |
| C | 52 | 42 |
| D | 45 | 37 |
| E | 17 | 8 |
| F | 37 | 14 |
| G | 43 | 35 |
| H | 50 | 30 |
| I | 45 | 20 |
| J | 49 | 30 |

Starting formulations have 50 g/L of pinoxaden. The method, intended for rapid screening, provides results to +/− about 10%.

### Example 2

### Performance of Emulsifiable Concentrates Upon Water Dilution

Emulsifiable concentrate samples are prepared containing pinoxaden (50 g/L) and cloquintocet-mexyl (12.5 g/L) in SOLVESSO™ 200 ND with 34 wt. % of either HALLCOMID® M-10 or STEPAN® 108 as the adjuvant. The proportion of two emulsifiers, NINATE® 60-EPG (calcium dodecylbenzene sulfonate) and TOXIMUL® 8241 (castor oil 30 EO ethoxylate), is varied to identify proportions suitable for use in incorporating the adjuvant into the emulsifiable concentrate. Each EC formulation is diluted to 1 vol. % in water having hardness values of 20 ppm or 342 ppm at 30° C. to evaluate emulsion stability.

Samples are prepared by first adding the emulsifiers to the aromatic hydrocarbon solvent and stirring until homogeneous. If necessary, the emulsifiers are warmed in a 50-60° C. oven prior to combination with the hydrocarbon solvent. Pinoxaden and the safener are then added and mixed until homogeneous.

To test emulsion stability, 100-mL graduated cylinders are charged with CIPAC standard water (20 or 342 ppm water, 99 mL). A pipette is used to feed the EC (1 mL) to each cylinder. The cylinders are stoppered and inverted ten times, then allowed to stand at 30° C. for 0.5, 1, 2, and 24 h while recording stability at each time with the type and amount of separation. After 24 h, the samples are again inverted ten times and a final measurement is taken after 0.5 h at rest.

Table 4 summarizes the emulsifiable concentrate formulations used for the aqueous emulsion stability tests. Results of the tests are shown in Table 5 for HALLCOMID® M-10 (comparative examples) and in Table 6 for STEPAN® 108 (inventive examples).

TABLE 4
Pinoxaden EC Formulations for Aqueous Emulsion Stability Tests

| Component | Formulation (wt. %) |
|---|---|
| pinoxaden (95.8%) | 5.36 |
| cloquintocet-mexyl (97.1%) | 1.34 |
| SOLVESSO ™ 200 ND solvent | 54.30 |
| NINATE ® 60 EPG + TOXIMUL ® 8241 | 5.0 |
| | (proportion varies |
| | per Tables 5 and 6) |
| HALLCOMID ® M-10 or STEPAN ® 108 | 34.0 |

TABLE 5
Aqueous Emulsion Stability: Adjuvant = HALLCOMID ® M-10
(comparative examples)

| NINATE ® 60EPG | | | 3.10 | 2.40 | 2.05 | 1.70 | 1.35 | 1.00 | 0.65 | 0.30 |
|---|---|---|---|---|---|---|---|---|---|---|
| TOXIMUL ® 8241 | | | 1.90 | 2.60 | 2.95 | 3.30 | 3.65 | 4.00 | 4.35 | 4.70 |
| 20 ppm | 0.5 | h | — | — | — | — | 0.5 C | 0.5 C | 1 C | — |
| water | 1.0 | h | — | — | — | — | 0.5 C | 0.5 C | 1.5 C | — |
| | 2.0 | h | — | — | — | — | 1 C | 1 C | 1.5 C | — |
| | 24 | h | — | — | — | — | 1 C | 1 C | 1 C | — |
| | 24 + 0.5 | h | — | — | — | — | 0 | 0 | 0 | — |
| 342 ppm | 0.5 | h | tr C | tr C | tr C | tr C | tr C | 0 | 0.5 C | 1 C |
| water | 1.0 | h | 1 C | 0.5 C | 0.5 C | tr C | 0.5 C | tr C | 0.5 C | 1 C |
| | 2.0 | h | 1.5 C | 1 C | 1.5 C | 0.5 C | 1 Co | 0.5 C | 0.5 C | 1 C |
| | 24 | h | 2 C + oil | 2 C | 2 C | 2 C | 1.5 Co | 1 oil | 1 C | 1 C |
| | 24 + 0.5 | h | 0.5 C | 1 C | 1 C | 1 C | 0 | 0 | 0 | 0 |

Wt. % of NINATE ® 60EPG and TOXIMUL ® 8241 is indicated (5 wt. % total emulsifier).
Numbers indicate volume of cream (C), creamy oil (Co), or oil in mL separated from the mixture at the time indicated. tr = trace. Best result is “0,” which indicates no apparent separation.

TABLE 6
Aqueous Emulsion Stability: Adjuvant = STEPAN ® 108 (inventive examples)

| NINATE ® 60EPG | | | 3.10 | 2.40 | 2.05 | 1.70 | 1.35 | 1.00 | 0.65 | 0.30 |
|---|---|---|---|---|---|---|---|---|---|---|
| TOXIMUL ® 8241 | | | 1.90 | 2.60 | 2.95 | 3.30 | 3.65 | 4.00 | 4.35 | 4.70 |
| 20 ppm | 0.5 | h | — | — | 0 | 0 | 0 | — | — | — |
| water | 1.0 | h | — | — | 0 | 0 | 0 | — | — | — |
| | 2.0 | h | — | — | 0 | 0 | tr C | — | — | — |
| | 24 | h | — | — | 0.5 C | 1 C | 1 C | — | — | — |
| | 24 + 0.5 | h | — | — | 0 | 0 | 0 | — | — | — |
| 342 ppm | 0.5 | h | tr Co | 0 | 0 | 0 | 0 | 0 | 0 | tr C |
| water | 1.0 | h | tr oil | tr Co | tr Co | 0 | 0 | 0 | tr C | tr C |
| | 2.0 | h | 0.5 oil | tr Co | tr Co | 0 | tr C | 0.5 C | 0.5 C | 1 C |
| | 24 | h | 1 oil | 1 Co | 1 Co | tr C | 1 C | 1 C | 1 C | 1 C |
| | 24 + 0.5 | h | tr oil | tr oil | tr oil | 0 | 0 | tr C | 0 | 0.5 C |

Wt. % of NINATE ® 60EPG and TOXIMUL ® 8241 is indicated (5 wt. % total emulsifier).
Numbers indicate volume of cream (C), creamy oil (Co), or oil in mL separated from the mixture at the time indicated. tr = trace. Best result is “0,” which indicates no apparent separation.

Despite the similar elevated-temperature stability performance in Example 1 between HALLCOMID® M-10 and STEPAN® 108, the results in Tables 5 and 6 demonstrate that STEPAN® 108 is the more-forgiving adjuvant when the EC formulations are diluted with standard waters at 20 ppm or 342 ppm total dissolved solids (TDS). A wider range of emulsifier combinations provides water-diluted formulations with no apparent separation. The results suggest that STEPAN® 108 will be the easier adjuvant with which to formulate.

### Example 3: EC Formulation for Greenhouse Testing

Formulations containing pinoxaden and 15 wt. % or 30 wt. % of STEPAN® 108 adjuvant are produced for evaluation in greenhouse testing. EC Formulation A contains pinoxaden (5.0 wt. %), cloquintocet-mexyl (1.2 wt. %), NINATE® 60 EPG anionic surfactant (2.0 wt. %), a nonionic surfactant blend (2.0 wt. %), STEPAN® 108 adjuvant (15.0 wt. %), and SOLVESSO™ 200 ND solvent (74.8 wt. %). EC Formulation B contains pinoxaden (5.0 wt. %), cloquintocet-mexyl (1.2 wt. %), NINATE® 60 EPG anionic surfactant (2.6 wt. %), a nonionic surfactant blend (2.4 wt. %), STEPAN® 108 adjuvant (30.0 wt. %), and SOLVESSO™ 200 ND solvent (58.8 wt. %).

### Storage Stability

Elevated-temperature storage stability of the formulations is evaluated by HPLC/UV upon preparation and following storage in an oven at 54° C. for 2 weeks. The mobile phase for HPLC is a gradient of acetonitrile/water with 10 mM ammonium formate and 0.1 wt. % formic acid. The column is a silica-based stationary phase modified with branched octadecyl groups. Reported values are an average of measurements from five samples. The values for pinoxaden content (quantified from the signal at 254 nm) for EC Formulation A (15% STEPAN® 108 adjuvant) range from 49.4 to 50.4 g/L, for an average of 98.2% retention of the original pinoxaden content after storage. This represents excellent storage stability.

### Aqueous Emulsion Stability

Stability of water-diluted samples at 25° C. is evaluated generally as described in Example 2 with some modifications. First, 5 mL of the test sample and 95 mL of the standard water are used (instead of 1 mL to 99 mL). Second, the samples are evaluated only at 0.5, 1, and 2 hours. Third, an experiment using 1000 ppm water is included. Results appear in Table 7 below.

TABLE 7
Aqueous Emulsion Stability: Adjuvant = 15 wt. %
or 30 wt. % STEPAN ® 108 adjuvant

| standard water | | time | | 15 wt. % adjuvant | 30 wt. % adjuvant |
|---|---|---|---|---|---|
| 20 | ppm | 0.5 | h | 0 | 0 |
| | | 1 | h | 0 | tr C |
| | | 2 | h | tr C | 1 C |
| 342 | ppm | 0.5 | h | 0 | 0 |
| | | 1 | h | 0 | 0 |
| | | 2 | h | 0.5 C | 0.5 C |
| 1000 | ppm | 0.5 | h | 0 | 0 |
| | | 1 | h | 0 | 0 |
| | | 2 | h | 3 Co | tr Co |

Numbers indicate volume of cream (C), creamy oil (Co), or oil in mL separated from the mixture at the time indicated. tr = trace. Best result is “0,” which indicates no apparent separation.

As shown in Table 7, the stability of the water-diluted EC samples is excellent.

### Example 4: Efficacy in Greenhouse Testing

The herbicidal efficacy of the formulations from Example 3 is assessed in a greenhouse test. The control formulation is AXIAL® Pratic (product of Syngenta). The experimental plan is summarized in Table 8, below. Each formulation is applied at stage BBCH 20-22 and is tested at the full dose (N=1.2 L/ha) as recommended on the AXIAL® Pratic label. Each formulation is also tested at reduced doses (N/4=0.3 L/ha and N/10=0.12 L/ha). A control experiment with water (Experiment No. 1) is also performed. Application volume: 225 L/ha; temperature: 22.7° C. to 24.6° C.; relative humidity: 53% to 86%.

Formulation efficacy is assessed against Lolium perenne (LOLPE), Avena fatua (AVEFA), Alopecurus myosuroides (ALOMY), and Agrostis capillaris (AGRCA). Each experiment is repeated four times, and each replicate includes three plants. Efficacy is assessed by visual observation 3, 7, 14 and 21 days after application and scored from 0-100% effective.

In addition to the herbicidal activity, the formulations of Example 3 are also weighed and checked for signs of phytotoxicity on winter wheat and winter barley.

TABLE 8
Efficacy and Phytotoxicity Protocol

| | Experiment Number | | | | | | | | | |
|---|---|---|---|---|---|---|---|---|---|---|
| | | 2 | 3 | 4 | 5 | 6 | 7 | | | |
| | 1 | Pinoxaden with 15% | | | Pinoxaden with 30% | | | 8 | 9 | 10 |
| | Control | STEPAN ® 108 | | | STEPAN ® 108 | | | AXIAL ® Pratic | | |
| | Dose | | | | | | | | | |
| | 0 | N | N/4 | N/10 | N | N/4 | N/10 | N | N/4 | N/10 |
| LOLPE | x | x | x | x | x | x | x | x | x | x |
| AVEFA | x | x | x | x | x | x | x | x | x | x |
| ALOMY | x | x | x | x | x | x | x | x | x | x |
| AGRCA | x | x | x | x | x | x | x | x | x | x |
| Winter wheat | x | x | | | x | | | x | | |
| Winter barley | x | x | | | x | | | x | | |

x = Experiment performed.

### RESULTS

As shown in FIGS. 2A and 2B, none of the tested formulations at full dose (N) exhibits noticeable phytotoxicity for either winter barley (FIG. 2A) or winter wheat (FIG. 2B).

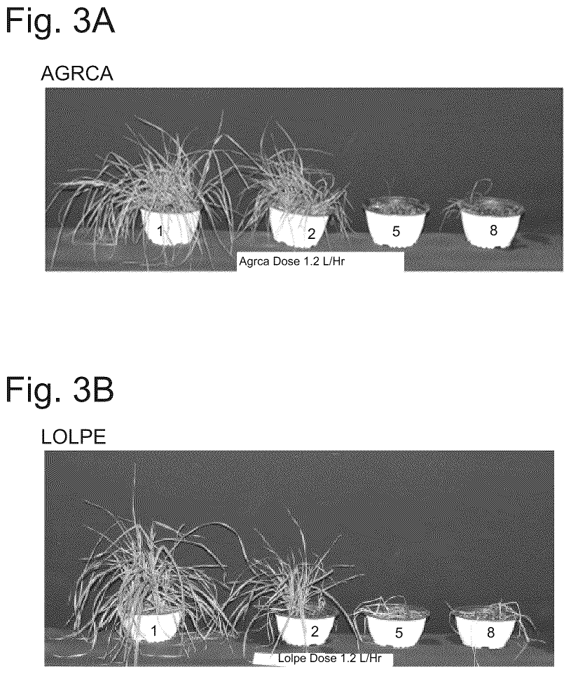

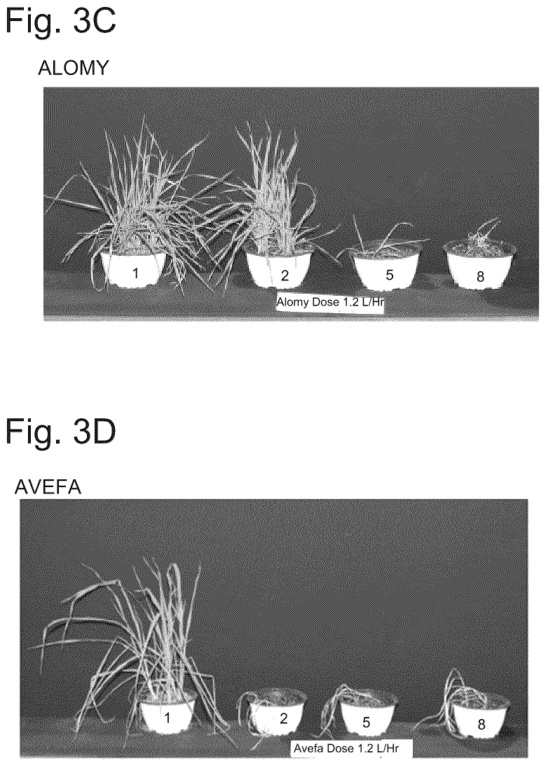

Results of herbicidal efficacy testing are shown in FIGS. 3A-3D and in Table 9. At full dose, the pinoxaden formulation with 30 wt. % STEPAN® 108 performs as well as AXIAL® Pratic, which includes 30 wt. % of tris(2-ethylhexyl)phosphate (Experiments 5 and 8; third and fourth samples from the left in FIGS. 3A-3D). The formulation with pinoxaden and 15 wt. % STEPAN® 108 (Experiment 2, second sample from the left in FIGS. 3A-3D) performs well on AVEFA, but not as well as pinoxaden and 30 wt. % STEPAN® 108 or AXIAL® Pratic on the other weeds. Reduced doses of STEPAN® 108 exhibit mixed results: better than the commercial sample on AVEFA, comparable performance on AG RCA, and poorer on LOLPE and ALOMY.

Overall, the results demonstrate good efficacy of pinoxaden formulations containing 30 wt. % STEPAN® 108 when compared with the commercial formulation that contains 30 wt. % of tris(2-ethylhexyl)phosphate.

TABLE 9
21-Day Efficacy (%)

| | Experiment Number | | | | | | | | | |
|---|---|---|---|---|---|---|---|---|---|---|
| | | 2 | 3 | 4 | 5 | 6 | 7 | | | |
| | 1 | Pinoxaden with 15% | | | Pinoxaden with 30% | | | 8 | 9 | 10 |
| | Control | STEPAN ® 108 | | | STEPAN ® 108 | | | AXIAL ® Pratic | | |
| | Dose | | | | | | | | | |
| | 0 | N | N/4 | N/10 | N | N/4 | N/10 | N | N/4 | N/10 |
| LOLPE | 0 | 56 | 0 | 0 | 100 | 100 | 8 | 100 | 98 | 79 |
| AVEFA | 0 | 100 | 100 | 73 | 100 | 75 | 9 | 100 | 30 | 30 |
| ALOMY | 0 | 29 | 0 | 0 | 100 | 14 | 0 | 100 | 93 | 33 |
| AGRCA | 0 | 15 | 19 | 0 | 100 | 21 | 0 | 100 | 30 | 9 |

The preceding examples are meant only as illustrations; the following claims define the scope of the invention.

We claim:

1. An agricultural concentrate comprising a 3-alkoxy-4-aryl-5-oxopyrazoline compound, an emulsifier, and an adjuvant comprising one or more C₆-C₁₄ triglycerides.

2. The concentrate of claim 1 comprising 3 to 8 wt. % of the 3-alkoxy-4-aryl-5-oxopyrazoline compound.

3. The concentrate of claim 1 wherein the 3-alkoxy-4-aryl-5-oxopyrazoline compound is pinoxaden.

4. The concentrate of claim 1 wherein the emulsifier is a combination of one or more nonionic surfactants and one or more anionic surfactants.

5. The concentrate of claim 4 wherein the anionic surfactant is an alkylbenzene sulfonate and the nonionic surfactant is selected from the group consisting of fatty alcohol ethoxylates, castor oil ethoxylates, ethoxylated fatty acids, and EO/PO block copolymers.

6. The concentrate of claim 1 wherein the C₆-C₁₄ triglycerides comprise C₈-C₁₂ triglycerides.

7. The concentrate of claim 1 wherein the C₆-C₁₄ triglycerides comprise C₈-C₁₀ triglycerides.

8. The concentrate of claim 1 further comprising a safener.

9. The concentrate of claim 8 wherein the safener comprises cloquintocet-mexyl.

10. The concentrate of claim 1 further comprising one or more organic solvents.

11. The concentrate of claim 10 wherein the organic solvent comprises an aromatic hydrocarbon having a flash point greater than 80° C.

12. The concentrate of claim 1 further comprising one or more insecticides, fungicides, bactericides, acaricides, nematicides, plant-growth regulators, or combinations thereof.

13. The concentrate of claim 1 further comprising an agricultural active selected from the group consisting of anilides; aryl carboxylic acids; aryloxyalkanoic acids; aryloxyphenoxyalkanoic acid esters; azinones; benzamides; benzenesulfonamides; benzofurans; benzoxazines; benzoic acids; benzothiadiazines; carbamates; carboxamides; chloroacetanilides; cineoles; cyclohexanediones; cyclohexenones; dinitroanilines; diphenyl ethers; dipyridyliums; 1,1-disubstituted oxiranes; hydroxylamines; imidazolinones; indanones, isoxazoles; isoxazolidinones; nitriles; organophosphonates; oxadiazolones; oxyacetamides; oxaziclomefones; phenoxyacetic acids; phenoxypropionates; picolinic acids; pyrazolylamides; pyrazolyloxyphenyls; pyrazoles; pyridazines; pyridine carboxylic acids; pyrimidines; pyrimidinediones; quinolinecarboxylic acids; sulfonamides; pyrrolidines; sulfonylanilides; sulfonylureas; thiolcarbamates; thioesters; thiophenes; triazines; triazoles; triazinones; triazolylpropanols; triones; uracils; ureas; azole-ureas; and the like, and combinations thereof.

14. The concentrate of claim 13 wherein the agricultural active is selected from the group consisting of diflufenican, propanil, dichloropicolinic acid, dicamba, picloram, 2,4-D, 2,4-DB, 2,4-DP, fluroxypyr, MCPA, MCPP, triclopyr, diclofop-methyl, fenoxaprop-ethyl, fluazifop-butyl, haloxyfop-methyl, quizalofop-ethyl, chloridazon, norflurazon, flamprop, benfuresate, ethofumesate, flumioxazin, bentazone, chlorpropham, desmedipham, phenmedipham, propham, napropamide, alachlor, acetochlor, butachlor, metazachlor, metolachlor, pretilachlor, propachlor, cinmethylin, tralkoxydim, oryzalin, pendimethalin, trifluralin, acifluorfen, bifenox, fluazifop, fluoroglycofen, fomesafen, halosafen, lactofen, oxyfluorfen, paraquat, tridiphane, alloxydim, clethodim, cycloxydim, sethoxydim, tralkoxydim, imazethapyr, imazamethabenz, imazamox, imazapic, imazapyr, imazaquin, indanofan, isoxaben, clomazone, bromoxynil, dichlobenile, ioxynil, glyphosates, glufosinates, oxadiazon, mefenacet, oxaziclomefone, aminopyralid, chlopyralid, difenzoquat, clopyralid, pyridate, pyridafol, pyroxsulam, saflufenacil, quinchlorac, quinmerac, florasulam, metosulam, flumetsulam, flurochloridone, amidosulfuron, bensulfuron methyl, chlorimuron ethyl, chlorsulfuron, cinosulfuron, flupyrsulfuron, foramsulfuron, mesosulfuron, metsulfuron-methyl, nicosulfuron, primisulfuron, pyrazosulfuron-ethyl, sulfosulfuron, thiencarbazone-methyl, thifensulfuron-methyl, triasulfuron, tritosulfuron, tribenuron-methyl, butylates, cycloates, diallates, EPTC, esprocarb, molinates prosulfocarb, thiobencarb, triallates, dithiopyr, methiozolin, atrazine, cyanazine, simazine, simetryne, terbutryne, terbutylazine, amitrol, hexazinone, metamitron, metribuzin, lenacil, bromacil, terbacil; chlortoluron, diuron, fluometuron, isoproturon, linuron, neburon, siduron, methabenzthiazuron, and combinations thereof.

15. An agricultural concentrate comprising:
(a) 1 to 20 wt. % of a 3-alkoxy-4-aryl-5-oxopyrazoline compound;
(b) 0.1 to 4 wt. % of a safener;
(c) 30 to 90 wt. % of one or more organic solvents;
(d) 0.5 to 20 wt. % of an emulsifier; and
(e) 5 to 50 wt. % of an adjuvant comprising one or more C₆-C₁₄ triglycerides; wherein the wt. % amounts are based on the amount of the concentrate.

16. The concentrate of claim 15 comprising 2 to 15 wt. % of pinoxaden, 0.2 to 2 wt. % of the safener; 40 to 80 wt. % of an aromatic hydrocarbon solvent; (d) 4 to 10 wt. % of the emulsifier; and (e) 10 to 35 wt. % of the adjuvant.

17. The concentrate of claim 15 comprising 4 to 6 wt. % of pinoxaden; 1 to 1.5 wt. % of cloquintocet-mexyl; 50 to 70 wt. % of an aromatic hydrocarbon solvent having a flash point greater than 80° C.; 1 to 7 wt. % of an emulsifier comprising a combination of a nonionic surfactant selected from the group consisting of fatty alcohol ethoxylates, castor oil ethoxylates, ethoxylated fatty acids, and EO/PO block copolymers and an anionic surfactant selected from alkylbenzene sulfonates; and 10 to 35 wt. % of the adjuvant, wherein the adjuvant comprises one or more C₈-C₁₀ triglycerides.

18. An emulsion, microemulsion, or suspoemulsion comprising water and the agricultural concentrate of claim 1.
